(19) United States
(12) Patent Application Publication
(10) Pub. No.: US 2010/0208459 A1
(43) Pub. Date: Aug. 19, 2010

(54) DIFFUSING ELEMENT AND LIGHT MODULE

(75) Inventors: Sheh-Jung Lai, Taichung County (TW); Yu-Feng Kuo, Taichung City (TW); Ta-Ho Yang, Changhua County (TW); Hsiang-Chun Lee, Taichung City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: WINTEK CORPORATION, Taichung (TW)

(21) Appl. No.: 12/704,531

(22) Filed: Feb. 12, 2010

(30) Foreign Application Priority Data
Feb. 17, 2009 (TW) 98105012

(51) Int. Cl. F21V 11/00; G02B 5/02

(52) U.S. Cl. 362/235; 359/599

(57) ABSTRACT

A diffusing element including a bar shape body and a plurality of light incident portions is provided. The bar shape body has a bottom part and a top part opposite thereto. The light incident portion is disposed on the bottom part and exposes a part of the bottom part. Each of the light incident portions has a light incident surface and a part of the bottom part is located between the light incident surface and the top part.

### CROSS-REFERENCE TO RELATED APPLICATION

This application claims the priority benefit of Taiwan application serial no. 98105012, filed on Feb. 17, 2009. The entirety of the above-mentioned patent application is hereby incorporated by reference herein and made a part of specification.

### BACKGROUND OF THE INVENTION

1. Field of the Invention

The present invention relates to an optical device and a light source module. More particularly, the present invention relates to a diffusing element and a light source module.

2. Description of Related Art

Liquid crystal display (LCD) has replaced cathode ray tube (CRT) display to become a mainstream in the market due to its advantageous such as low voltage operation, no radiation, light-weight, and small-size, etc. In the LCD device, liquid crystal molecules function as a display media, and since the liquid crystal molecule is non-emissive, a light-emitting device has to be configured in the LCD device to achieve a display function.

In various light-emitting devices, light-emitting diodes (LEDs) are generally applied to various electronic devices, information board and communication productions due to its advantages of small-size, long lifespan, low driving voltage, low power consumption, fast response rate, good shock-resisting capability and good mono-chromaticity, etc. Certainly, the LEDs are also widely applied to the LCD devices to provide suitable light sources.

Actually, when the requirement of a relatively great light source area is request in a product, a plurality of LEDs is generally applied. Each of the LEDs has a certain light-emitting angle, and a direct-view luminance of the LED is generally great. Therefore, the brightness represented in the area where a gap among the LEDs is differs from that represented in the area where a center of the LED is. Namely, when the LEDs are used as the light source of a display device, there probably has a problem of uneven light distribution.

### SUMMARY OF THE INVENTION

The present invention is directed to a diffusing element, which can provide different optical properties in allusion to different regions.

The present invention is directed to a light source module, which can resolve a problem of uneven light distribution of a light source module formed by point light sources.

The present invention provides a diffusing element including a bar-shape body and a plurality of light incident portions. The bar-shape body has a bottom part and a top part opposite to the bottom part. The light incident portions are disposed on the bottom part of the bar-shape body, and expose a part of the bottom part. Each of the light incident portions has a light incident surface, and a part of the bottom part is located between the light incident surface and the top part.

The present invention further provides a light source module including an accommodating device, a plurality of point light sources and at least one diffusing element. The accommodating device has an accommodating portion and a plurality of wedging portions. The point light sources are disposed in the accommodating portion of the accommodating device, and each of the point light sources has a light-emitting surface. The diffusing element is wedged in the wedging portions. The diffusing element includes a body and a plurality of light incident portions. The body has a bottom part and a top part opposite to the bottom part. The light incident portions are disposed on the bottom part of the body, and expose part of the bottom part. Each of the light incident portions has a light incident surface, and a part of the bottom part is located between the light incident surface and the top part, and the light incident surface is located above the light-emitting surface, so that the light incident surface is faced to the light-emitting surface.

In an embodiment of the present invention, the body and the light incident portions are formed integrally.

In an embodiment of the present invention, the body is bar-shaped, and has a V-shape cross-section which takes an axial direction of the body as a normal line. Moreover, an included angle of the V-shape cross-section is 300 to 1350. The light incident portions are at least located in a region surrounded by the V-shape cross-section. The light incident surfaces are apart from the top part of the body, and two opposite sides of each of the light incident surfaces are connected to the bottom part of the body. A cross-section of each of the light incident portions that takes the axial direction as a normal line is a triangle. A cross-section of each of the light incident portions intersecting and equally dividing the V-shape cross-section is a rectangle, a trapezoid, a semi-ellipse, or a hemicycle. Moreover, each of the light incident portions further protrudes out from the region, and the light incident surface is located apart from the top part of the body.

In an embodiment of the present invention, a minimum distance between a projection area of each of the point light sources orthographically projected on the corresponding light incident surface and an edge of the diffusing element is 0.5 mm to 1.5 mm.

In an embodiment of the present invention, the body is plate-shaped. The light incident portions are disposed on the bottom part and extend along a first direction. A width of a cross-section of the light incident portion that takes such first direction as a normal line is gradually reduced along a second direction departing the top part from the bottom part. Moreover, the cross-section of the light incident portion that takes such first direction as the normal line is a rectangle, a trapezoid, a semi-ellipse, or a hemicycle.

In an embodiment of the present invention, in the light source module, a minimum distance between each of the light-emitting surfaces and the corresponding light incident surface is 0.1 mm to 0.3 mm.

In an embodiment of the present invention, a haze of the diffusing element is above 70.

In the present invention, the diffusing element is designed to have uneven thickness. when the diffusing element is applied to the light source module, a relatively thick portion of the diffusing element is disposed corresponding to a position with relatively high light intensity, and a relatively thin portion of the diffusing element is disposed corresponding to a position with relatively weak light intensity. Therefore, the light source module may have an even light-emitting effect. In brief, in the present invention, a light-emitting evenness of the light source module can be adjusted according to a characteristic of the diffusing element which is the uneven light transmissivity due to the uneven thickness. Therefore, the light source module of the present invention can provide the even light-emitting effect.

In order to make the aforementioned and other features and advantages of the present invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating a light source module according to an embodiment of the present invention.

FIG. 2A is a diagram illustrating a diffusing element according to a first embodiment of the present invention.

FIG. 2B is a diagram illustrating a configuration relation of a point light source and a diffusing element.

FIG. 3A is a bottom view of a diffusing element of FIG. 2.

FIG. 3B is a cross-sectional view along an axial direction of FIG. 3A.

FIG. 4A and FIG. 4B are respectively a bottom view and a cross-sectional view of a diffusing element according to a second embodiment of the present invention.

FIG. 5A and FIG. 5B are respectively a bottom view and a cross-sectional view of a diffusing element according to a third embodiment of the present invention.

FIG. 6A and FIG. 6B are respectively a bottom view and a cross-sectional view of a diffusing element according to a fourth embodiment of the present invention.

FIG. 7A is a diagram illustrating a diffusing element according to a fourth embodiment of the present invention.

FIG. 7B is a cross-sectional view of a diffusing element of FIG. 7A.

FIG. 8A and FIG. 8B are respectively a diagram of a diffusing element and a cross-sectional view thereof according to a fifth embodiment of the present invention.

### DESCRIPTION OF EMBODIMENTS

If LEDs are used as light-emitting devices of a light source module, limited by a light-emitting angle and an arrangement layout of the LEDs, the light source module cannot provide an even light-emitting effect. Therefore, the present invention provides a diffusing element having a specific structure for resolving the problem of the uneven light-emitting when such point light sources of the LEDs are applied.

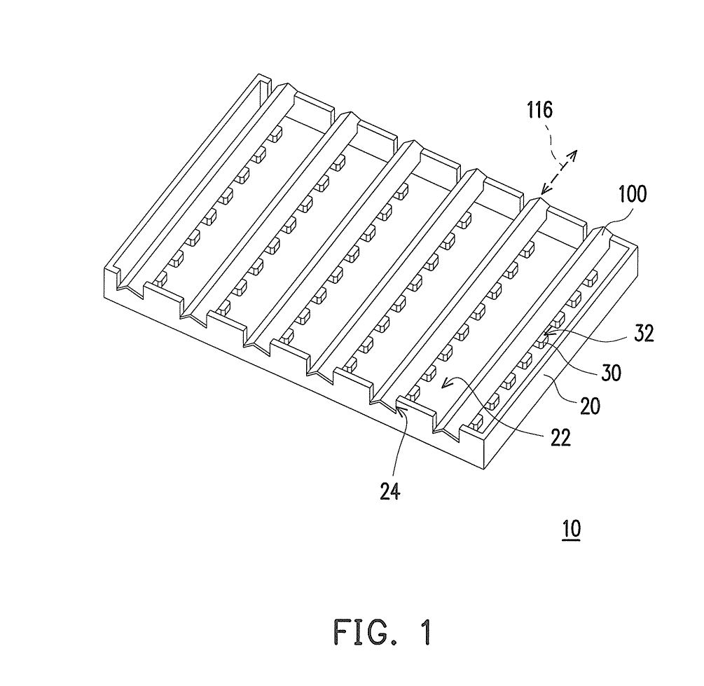

FIG. 1 is a schematic diagram illustrating a light source module according to an embodiment of the present invention. The light source module 10 includes an accommodating device 20, a plurality of point light sources 30, and a plurality of diffusing elements 100. The accommodating device 20 has an accommodating portion 22, and a plurality of wedging portions 24. The point light sources 30 are disposed in the accommodating portion 22 of the accommodating device 20, and each of the point light sources 30 has a light-emitting surface 32. The diffusing elements 100 are wedged in the wedging portions 24. Substantially, the point light source 30 is, for example, a LED.

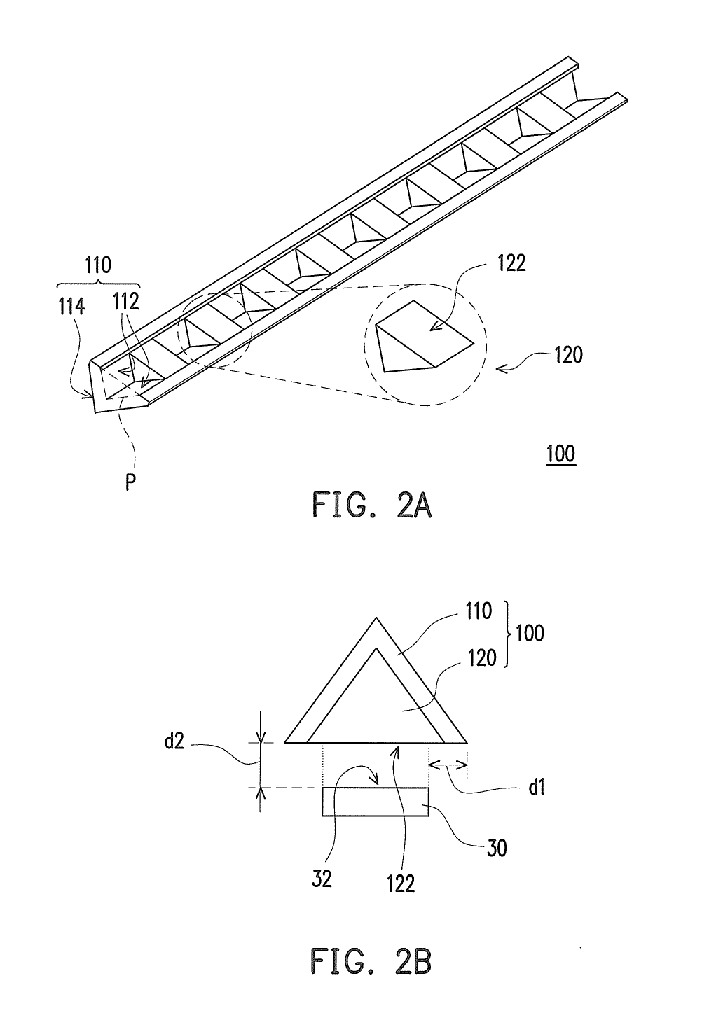

FIG. 2A is a diagram illustrating a diffusing element according to a first embodiment of the present invention. Referring to FIG. 1 and FIG. 2A, the diffusing element 100 includes a bar-shape body 110 and a plurality of light incident portions 120. The bar-shape body 110 has a bottom part 112 and a top part 114 opposite to the bottom part 112. The light incident portions 120 are disposed on the bottom part 112 of the bar-shape body 110, and expose a part of the bottom part 112. Each of the light incident portions 120 has a light incident surface 122, and a part of the bottom part 112 is located between the light incident surface 122 and the top part 114. In the light source module 10, the light incident surfaces 122 face to the light-emitting surfaces 32 of the point light sources 30. In the present embodiment, the bar-shape body 110 and the light incident portions 120 are formed integrally.

Generally, the point light sources 30 are, for example, LEDs having a certain light-emitting angle, and a region right above the point light source 30 generally represent relatively higher luminance. Therefore, when a plurality of the point light sources 30 simultaneously emits light, uneven bright points may appear in the light source module 10. To achieve an even light-emitting effect of the light source module 10, in the present embodiment, the diffusing elements 100 are correspondingly disposed above the point light sources 30. The diffusing element 100 is made of a plastic material and scattering particles mixed in the plastic material, for example, a poly methyl methacrylate (PMMA) material or a poly carbonate (PC) material mixed with white TiO2 scattering particles therein. A haze of the diffusing element 100 is generally above 70. When the light incident portion 120 is correspondingly disposed above the light-emitting surface 32, since the light incident portion 120 has a certain haze, the light above the light-emitting surface 32 can be diffused and hazed. Therefore, when the light source module 10 is lighted, the bright point phenomenon right above the light-emitting surface 32 (i.e. the uneven light distribution phenomenon) can be mitigated.

The translucent diffusing element 100 can not only diffuse the light emitted from the point light sources 30, a portion of the diffusing element 100 that is thicker than other portions can also provide a certain degree of light scattering and shielding effect. Therefore, to compensate the relatively high luminance of the region above the point light source 30 in the light source module 10, in the present embodiment, the bar-shape body 110 and the light incident portion 120 are disposed at the region above the light-emitting surface 32, and a material thickness of the region is a sum of the material thickness of the bar-shape body 110 and the material thickness of the light incident portion 120. Therefore, the diffusing element 100 provides a relatively high light scattering and shielding effect right above the light-emitting surface 32, so as to achieve the even light-emitting effect of the light source module 10.

In detail, the bar-shape body 110 is bar-shaped, and has a V-shape cross-section, wherein the V-shape cross-section (not shown) takes an axial direction 116 of the bar-shape body 110 as a normal line. Substantially, an included angle of the V-shape cross-section (not shown) is 300 to 1350, and the V-shape cross-section (not shown) of the bar-shape body 110, for example, encloses a triangle region P. The light incident portions 120 are at least located in the triangle region P surrounded by the V-shape cross-section (not shown). Namely, the light incident portions 120 are disposed in the triangle region P. Moreover, at least a part of the bottom part 112 is located between the light incident surface 122 and the top part 114, and two opposite sides of each of the light incident surfaces 122 are connected to the bottom part 112 of the bar-shape body 110. By such a structure described above, a cross-section of the light incident portion 120 that takes the axial direction 116 as a normal line is a triangle (shown as a partial amplified diagram in FIG. 2A). Herein, the light incident portion 120 is, for example, a triangle column embedded in the bar-shape body.

FIG. 2B is a diagram illustrating a configuration relation of the point light source and the diffusing element. Referring to FIG. 2B, preferably, a minimum distance d1 between a projection area of each of the point light sources 30 orthographically projected on the corresponding light incident surface 122 and an edge of the diffusing element 100 is, for example, 0.5 mm to 1.5 mm. Moreover, a minimum distance d2 between each of the light-emitting surfaces 32 and the corresponding light incident surface 122 can be 0.1 mm to 0.3 mm.

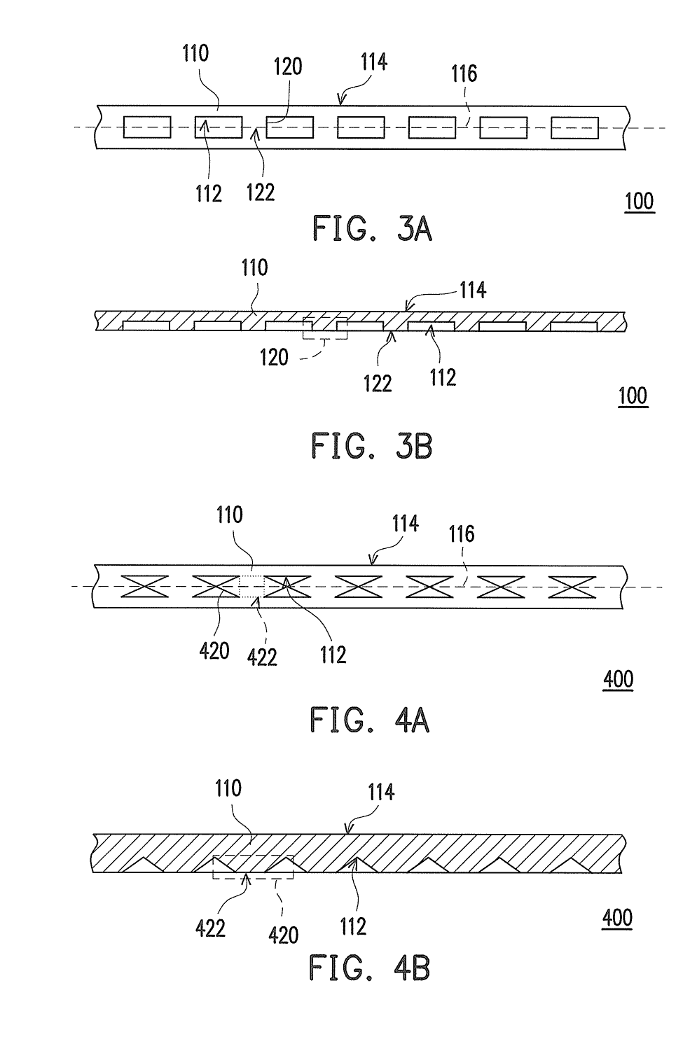

Moreover, FIG. 3A and FIG. 3B are respectively a bottom view and a cross-sectional view of the diffusing element of FIG. 2, wherein FIG. 3B is a cross-sectional view along an axial direction of FIG. 3A. Herein, the axial direction is represented by the dash line in FIG. 3A. Referring to FIG. 3A and FIG. 3B, a cross-section of each of the light incident portions 120 intersecting and equally dividing the V-shape cross-section (not shown) of the bar-shape body 110 is, for example, a rectangle. Moreover, a position which the light incident portion 120 is located at is thicker than other portions in thickness, so that the position where the light incident portion 120 of the diffusing element 100 is located can provide a better light scattering and shielding effect.

In the present embodiment, a portion of the diffusing element 100 which the light incident portion 120 is located at, for example, is thicker than other portions and right above the light-emitting surface 32, though the present embodiment is not limited thereto. Since the diffusing element 100 can compensate the luminance in different regions, in other embodiments, a portion of the diffusing element 100 that is thicker than other portions can be disposed at other positions where the light is probably concentrated, or at a position requiring a relatively low light intensity.

Certainly, the diffusing element of the present invention is not limited to such structure design, and FIG. 4A and FIG. 4B are respectively a bottom view and a cross-sectional view of a diffusing element according to a second embodiment of the present invention. Referring to FIG. 4A and FIG. 4B, the diffusing element 400 is similar to the aforementioned diffusing element 100, so that a part of the device symbols of the diffusing element 400 is the same as that of the diffusing element 100. Though, the light incident portions 420 are different from the aforementioned light incident portions 120. A cross-section of each of the light incident portions 420 intersecting and equally dividing the V-shape cross-section (not shown) of the bar-shape body 110 is, for example, a trapezoid.

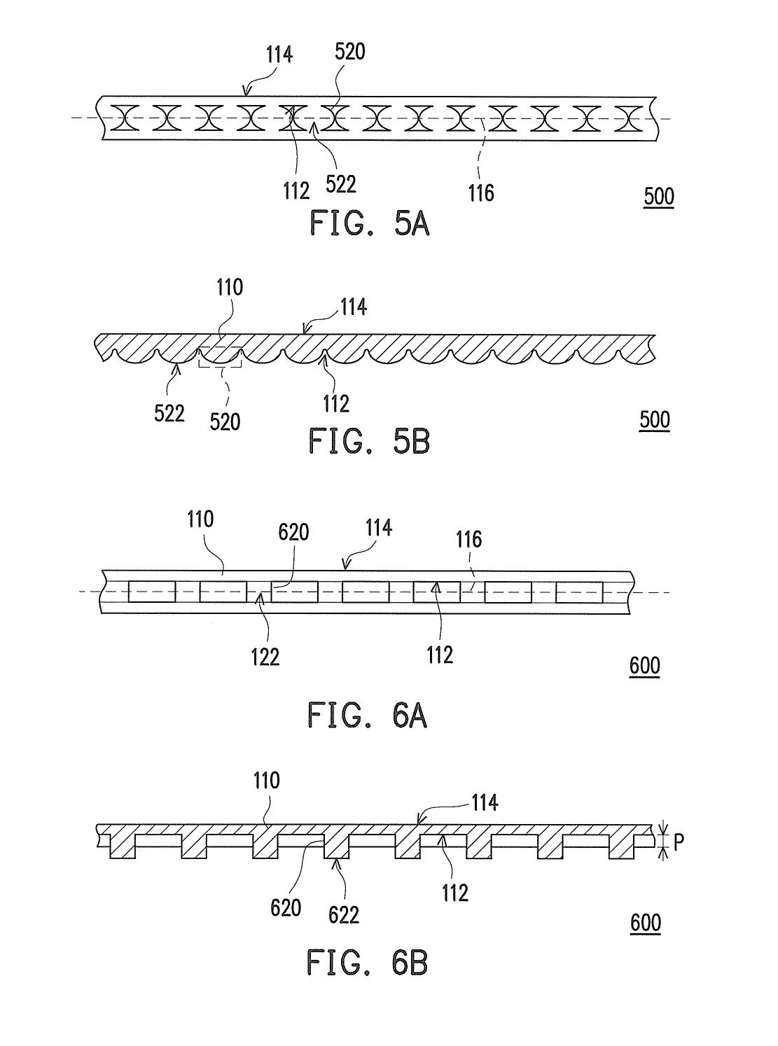

Moreover, the structure of the diffusing element 100 and the diffusing element 400 may have other variations. For example, FIG. 5A and FIG. 5B are respectively a bottom view and a cross-sectional view of a diffusing element according to a third embodiment of the present invention. Referring to FIG. 5A and FIG. 5B, a cross-section of each of the light incident portions 520 intersecting and equally dividing the V-shape cross-section (not shown) of the bar-shape body 110 is, for example, a semi-ellipse or a hemicycle. Namely, the light incident portion 520 of the diffusing element 500 has a curved light incident surface 522.

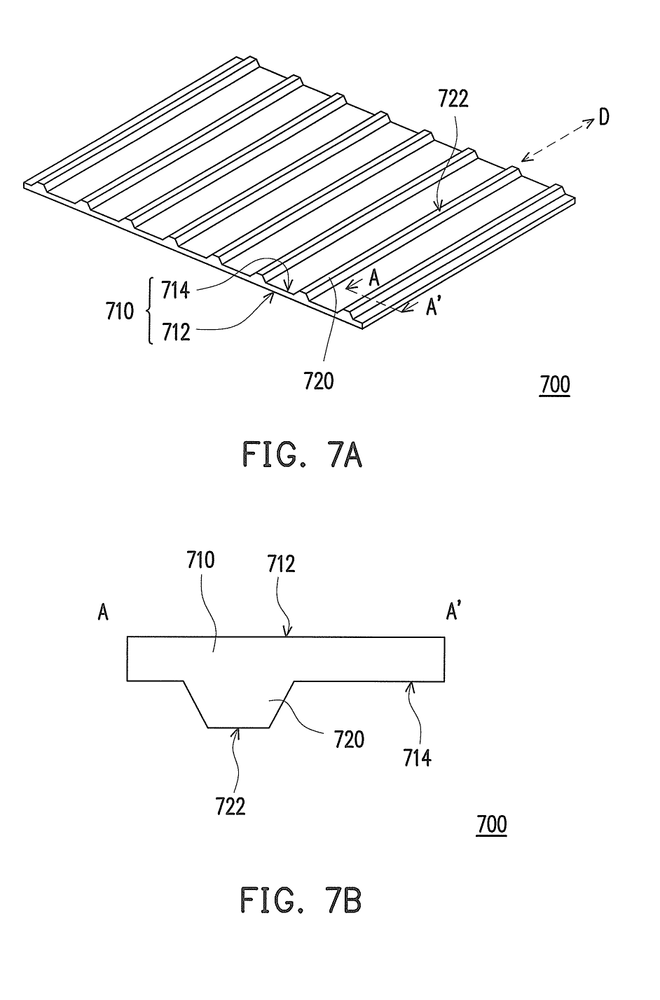

Further, FIG. 6A and FIG. 6B are respectively a bottom view and a cross-sectional view of a diffusing element according to a fourth embodiment of the present invention. Referring to FIG. 6A and FIG. 6B, the diffusing element 600 is similar to the diffusing element 100. In particular, each of the light incident portions 620 can protrude out from the region P, and each of the light incident surfaces 622 is located apart from the top part 114 of the bar-shape body 110, and is located outside the region P. In other words, the light incident portion 620 is not only located inside the region P, but a part of the light incident portion 620 further protrudes out from the region P. In the present embodiment, the protruded part of the light incident portion 620, for example, has a rectangular cross-section, and in other embodiments, the protruded part of the light incident portion 620 may have a trapezoid cross-section, a semi-elliptical cross-section, or a hemicyclic cross-section, etc. Certainly, the light incident surface 622 is located at the protruded part of the light incident portion 620, and the light incident surface 622 can be a planar surface or a curved surface. Moreover, when the diffusing element 600 is assembled to a light source module, a configuration relation between the diffusing element 600 and the point light sources of the light source module can be similar to the configuration relation between the diffusing element 100 and the point light sources 30 of FIG. 2B.

Besides the bar-shape body 110, the diffusing element of the present invention may have different structure designs. FIG. 7A is a diagram illustrating a diffusing element according to a fourth embodiment of the present invention, and FIG. 7B is a cross-sectional view of the diffusing element of FIG. 7A. Referring to FIG. 7A and FIG. 7B, the diffusing element 700 includes a body 710 and a plurality of light incident portions 720. The body 710 has a bottom part 712 and a top part 714 opposite to the bottom part 712. In the present embodiment, the body 710 is plate-shaped, so that the bottom part 712 and the top part 714 are, for example, two parallel planes.

Moreover, the light incident portion 720 is disposed on the bottom part 712 of the body 710, and exposes a part of the bottom part 712, wherein each of the light incident portion 720 has a light incident surface 722, and a part of the bottom part 712 is located between the light incident surface 722 and the top part 714. In the present embodiment, the body 710 and the light incident portion 720 are also formed integrally. Substantially, the light incident portion 720 is disposed on the bottom part 712, and extends along a direction D. According to FIG. 7B, a width of a cross-section of the light incident portion 720 that takes such direction D as a normal line is gradually reduced along a direction departing the top part from the bottom part. Actually, in the present embodiment, the cross-section of the light incident portion 720 that takes such direction D as a normal line is a trapezoid.

When the diffusing element 700 is assembled to a light source module, the light incident surface 722 is made to face to the light source, so that the light incident portion 720 must be disposed facing to the light source, and the bottom part 712 is apart from the light source. The diffusing element 700 is also a translucent device fabricated by a plastic material and scattering particles mixed in the plastic material. Therefore, a relatively thick position on the diffusing element 700, i.e. a position where the light incident portion 720 is located can not only provide light scattering effect, but can also provide a certain light-shielding effect. Therefore, the light incident portion 720 is disposed right above the light source to reduce a light-emitting luminance right above the light source, so as to improve a light-emitting evenness of the light source module.

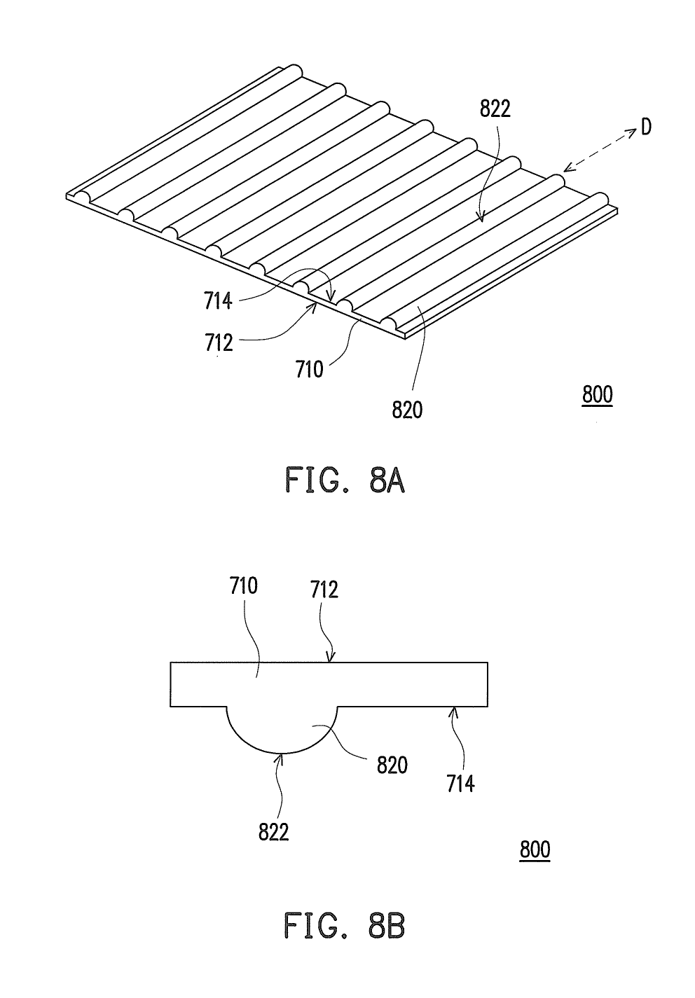

FIG. 8A and FIG. 8B are respectively a diagram of a diffusing element and a cross-sectional view thereof according to a fifth embodiment of the present invention. Referring to FIG. 8A and FIG. 8B, the diffusing element 800 is approximately the same as the diffusing element 700, and a difference therebetween is that a cross-section of the light incident portion 820 in the diffusing element 800 that takes the direction D as the normal line is a semi-ellipse, or a hemicycle. Namely, the light incident surface 822 is not a plane, but is an arc surface. The light incident portion 820 protrudes out from the bottom part 714, so that the material thickness of such region of the diffusing element 800 is thicker than other portions. Therefore, when the diffusing element 800 is assembled to a light source module with uneven light distribution, the light incident portion 820 can be correspondingly disposed at a position with relatively high light intensity to improve the light-emitting evenness of the light source module.

In summary, in the present invention, different regions of the diffusing element may have different material thickness according to the design of the light incident portion. Therefore, when the diffusing element of the present invention is applied to the light source module, the light-emitting luminance of the light source module can be compensated according to different light transmissivities of the regions with different material thickness. In an application, the light incident portion may be disposed corresponding to the light-emitting surface of the light source, so that the diffusing element avails reducing the light intensity of the region right above the light-emitting surface of the light source so as to achieve the even light-emitting effect. In other words, the diffusing element of the present invention can not only provide a suitable light scattering effect, but can also lead to a better light-emitting effect of the light source module.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A diffusing element, comprising:
a bar-shape body having a bottom part and a top part opposite to the bottom part; and
a plurality of light incident portions disposed on the bottom part of the bar-shape body, and exposing a part of the bottom part, wherein each of the light incident portions has a light incident surface, and a part of the bottom part is located between the light incident surfaces and the top part,
wherein the bar-shape body and the light incident portions are formed integrally, and a haze of the diffusing element is above 70.

2. The diffusing element as claimed in claim 1, wherein the bar-shape body has a V-shape cross-section which takes an axial direction of the bar-shape body as a normal line, and an included angle of the V-shape cross-section is 30° to 135°.

3. The diffusing element as claimed in claim 2, wherein the light incident portions are at least located in a region surrounded by the V-shape cross-section.

4. The diffusing element as claimed in claim 3, wherein the light incident surfaces are apart from the top part of the bar-shape body, and two opposite sides of each of the light incident surfaces are connected with the bottom part of the bar-shape body.

5. The diffusing element as claimed in claim 4, wherein a cross-section of each of the light incident portions that takes the axial direction as a normal line is a triangle.

6. The diffusing element as claimed in claim 4, wherein a cross-section of each of the light incident portions intersecting and equally dividing the V-shape cross-section is a rectangle, a trapezoid, a semi-ellipse, or a hemicycle.

7. The diffusing element as claimed in claim 3, wherein each of the light incident portions further protrudes out from the region, and the light incident surface is apart from the top part of the bar-shape body.

8. A light source module, comprising:
an accommodating device having an accommodating portion and a plurality of wedging portions;
a plurality of point light sources disposed in the accommodating portion of the accommodating device, and each of the point light sources having a light-emitting surface; and
at least one diffusing element wedged in the wedging portions, and the diffusing element comprising:
a body having a bottom part and a top part opposite to the bottom part; and
a plurality of light incident portions disposed on the bottom part of the body, and exposing a part of the bottom part, wherein each of the light incident portions has a light incident surface, a part of the bottom part is located between the light incident surfaces and the top part, and the light incident surfaces are located above the light-emitting surface, so that the light incident surfaces face to the light-emitting surface,
wherein a haze of the diffusing element is above 70.

9. The light source module as claimed in claim 8, wherein the body and the light incident portions of the diffusing element are formed integrally.

10. The light source module as claimed in claim 8, wherein the body of the diffusing element is bar-shaped.

11. The light source module as claimed in claim 10, wherein the body has a V-shape cross-section which takes an axial direction of the body as a normal line, and an included angle of the V-shape cross-section is 30° to 135°.

12. The light source module as claimed in claim 11, wherein the light incident portions are at least located in a region surrounded by the V-shape cross-section.

13. The light source module as claimed in claim 12, wherein the light incident surfaces of the diffusing element are apart from the top part of the body, and two opposite sides of each of the light incident surfaces are connected with the bottom part of the body.

14. The light source module as claimed in claim 13, wherein a cross-section of each of the light incident portions that takes the axial direction as a normal line is a triangle.

15. The light source module as claimed in claim 13, wherein a cross-section of each of the light incident portions intersecting and equally dividing the V-shape cross-section is a rectangle, a trapezoid, a semi-ellipse, or a hemicycle.

16. The light source module as claimed in claim 13, wherein a minimum distance between a projection area of each of the point light sources orthographically projected on the corresponding light incident surface and an edge of the diffusing element is 0.5 mm to 1.5 mm.

17. The light source module as claimed in claim 12, wherein each of the light incident portions further protrudes out from the region, and the light incident surfaces are located apart from the top part of the body.

18. The light source module as claimed in claim 8, wherein the body of the diffusing element is plate-shaped and the light incident portions are disposed on the bottom part and extend along a first direction.

19. The light source module as claimed in claim 18, wherein a width of a cross-section of each of the light incident portions that takes the first direction as a normal line is gradually reduced along a second direction departing the top part from the bottom part.

20. The light source module as claimed in claim 19, wherein a cross-section of each of the light incident portions that takes the first direction as a normal line is a rectangle, a trapezoid, a semi-ellipse, or a hemicycle.

21. The light source module as claimed in claim 8, wherein a minimum distance between each of the light-emitting surfaces and the corresponding light incident surface is 0.1 mm to 0.3 mm.
